(19) United States
(12) Patent Application Publication
(10) Pub. No.: US 2006/0204355 A1
(43) Pub. Date: Sep. 14, 2006

(54) HYDRAULIC LIFT FOR A MOTOR VEHICLE PLATFORM

(76) Inventor: James Demetrios Makarikas, Cheektowaga, NY (US)

Correspondence Address: WILLIAM COLLARD;COLLARD & ROE, P.C., 1077 NORTHERN BOULEVARD, ROSLYN, NY, 11576, US

(21) Appl. No.: 10/906,921

(22) Filed: Mar. 12, 2005

(51) Int. Cl. B62D 21/14

(52) U.S. Cl. 414/495

(57) ABSTRACT

A device for moving a platform on a motor vehicle comprising, at least one hydraulic system, at least one container coupled to the motor vehicle, and at least one platform coupled to the container. There can be at least one hinge rotatably coupling the platform to the container. There can also be a hydraulic piston in communication with the hydraulic system, wherein the hydraulic piston is for selectively moving the platform from a first position to at least one additional position. To hold the platform in place there is a safety arm, which can include a locking means for locking the safety arm in place. The locking means can include at least one locking pin that fits into a groove to lock any movement of a rotating arm to prohibit the arm from rotating back once the hydraulic piston has moved the platform into position.

### BACKGROUND OF THE INVENTION

The invention relates to an automatic lift apparatus for lifting a platform into place. The platform may be used for maintenance, repair or construction purposes and it may be associated with a tractor trailer.

At least one other lift apparatus is known to be associated with a motor vehicle. For example, U.S. Pat. No. 5,586,856 to Springer discloses a lift apparatus the disclosure of which is hereby incorporated herein by reference.

### SUMMARY OF THE INVENTION

One embodiment of the device relates to a device for moving a platform on a motor vehicle comprising, at least one hydraulic system, at least one container or hopper coupled to the motor vehicle and at least one platform coupled to the container. There can be at least one hinge rotatably coupling the platform to the container. There can also be a hydraulic piston in communication with the hydraulic system, wherein the hydraulic piston is for selectively moving the platform from a first position to at least one additional position.

To hold the platform in place there is a safety arm which can include a locking means for locking the safety arm in place. The locking means can include at least one locking pin that fits into a groove or hole to lock any movement of a rotating arm to prohibit the arm from rotating back once the hydraulic piston has moved the platform into position. This safety arm is important so that the platform will not collapse once the platform is in place even if the piston collapses. In addition at this point, once the safety arm is locked in place, the hydraulic system can be shut down until the platform has to be moved back.

The hydraulic piston can be coupled to the container at a first end and coupled to the platform at a second end. In addition, the device can also optionally comprise at least one substantially vertical hydraulic piston for providing vertical adjustment for the container. There can also be a trailer wherein the container can be coupled to the trailer.

The hydraulic piston can be coupled to the container at a first end and coupled to the platform at a second end. In this case, the device can also include at least one substantially vertical hydraulic piston for providing vertical adjustment for the container above the trailer.

The substantially vertical hydraulic piston can be coupled to the container at a first end and to the trailer at a second end, wherein the vertical hydraulic piston is for elevating the container off of the trailer.

Alternatively, the substantially vertical hydraulic piston can be coupled to the trailer at a first end and be supported on a substantially horizontal surface at a second end, wherein the substantially vertical hydraulic piston can be for elevating the trailer off of the substantially horizontal surface. Stabilizing support bars can also be used to support the trailer in place once the platform has been raised. In addition additional stabilizing support bars can be used to support the container above the trailer surface.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a side view of an embodiment of the device;

FIG. 2 is a end view of the view shown in FIG. 1;

FIG. 3A is a side view of a safety arm;

FIG. 3B is a side view of a bracket on the safety arm; and

FIG. 4 is a top view of the platform and the container wherein the platform is in an extended position.

### DETAILED DESCRIPTION OF PREFERRED EMBODIMENTS

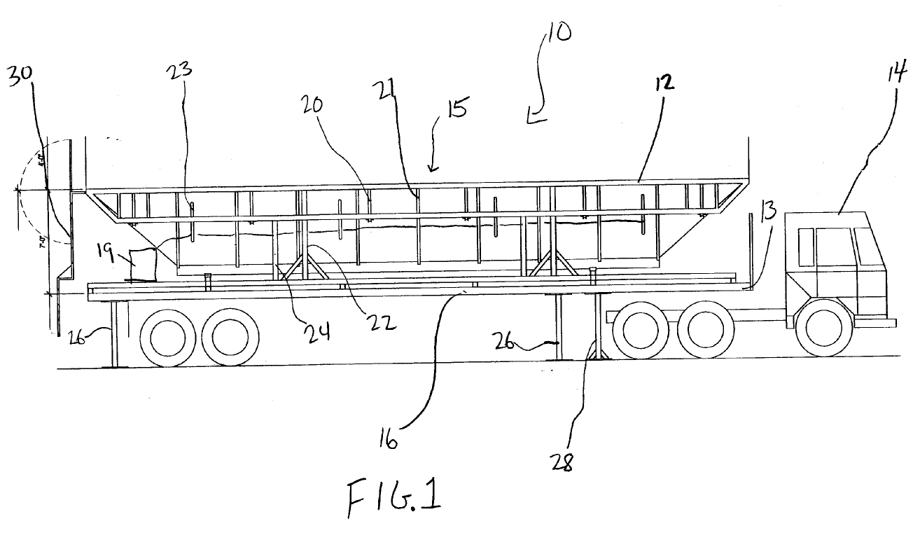

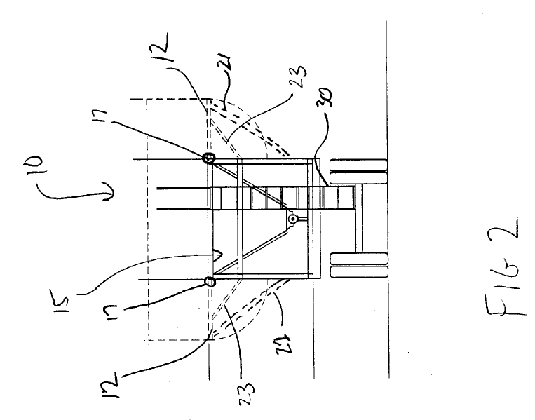

Turning now in detail to the drawings, FIG. 1 shows a side view of a first embodiment of the device 10 wherein this device includes a platform 12 and container 15 which can be optionally coupled to a motor vehicle such as a truck 14 via a trailer 16. This platform 12 is shown in a rotated up position wherein as shown in FIG. 2, this platform 12 can rotate up from a resting down position to a substantially horizontally extending upright position around hinge 17. A hydraulic system 19 can be disposed on trailer 16 and be used to operate and drive a hydraulic piston lift 23 which can be used to push and rotate out platform 12 from a first down or substantially vertical position to a second, substantially horizontal position.

This device can also include substantially vertical hydraulic jacks 24 which can be used with hydraulic system 19 to selectively elevate container 15 off of a trailer 13. In this case, hydraulic jacks 24 are activated to press up on a stabilizing bar coupled to container 15 to raise container 15 up off of trailer 16. To secure container 15 in place, vertical support bars 22 are used which can be used to mechanically lock container 15 in place at a particular elevation.

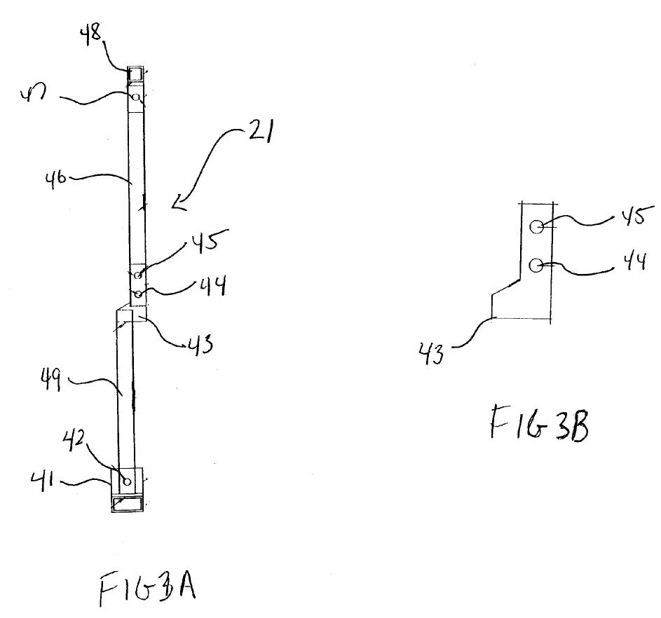

There can also be a stabilizing bar 21, which can function as a mechanical lock and be moved and locked into place once the hydraulic system is operated to rotate the platform into its operating and substantially horizontal position. Stabilizing bar or safety bar 21 is shown in an extended position in FIG. 2. In addition, the different components of stabilizing bar 21 are shown in FIGS. 3A and 3B.

FIGS. 3A and 3B show the different components of stabilizing or safety bar 21. Bar 21, includes a connecting bracket 41 which can be coupled to container 15 either directly or indirectly. Connecting bracket 41 includes a hinge 42 which allows a shaft 49 to rotate. Shaft 49 can be rotated about via a hinge 42 which is used to couple shaft 49 to bracket 42.

Shaft 49 can be fixedly connected at an opposite end to a connecting bracket 43. Connecting bracket 43 as shown in FIG. 3B has two holes 44 and 45 designed to receive locking pins. A shaft 46 is rotatably coupled to bracket 43. Shaft 46 can be locked in place by inserting pins into pin holes 44 and 45 to lock shaft 46 in place. Shaft 46 is coupled at its opposite end to a connecting bracket 48 which can be coupled to platform 12. Connecting bracket 48 and shaft 46 have a hinge 47 which can be used to allow shaft 46 to rotate via bracket 48. Once hydraulic piston 23 rotates platform 12 into position, it can be locked in place via locking pins fitting through holes 44, and 45. Locking pins 44 and 45 are used to lock shaft 46 from rotating vs. bracket 43.

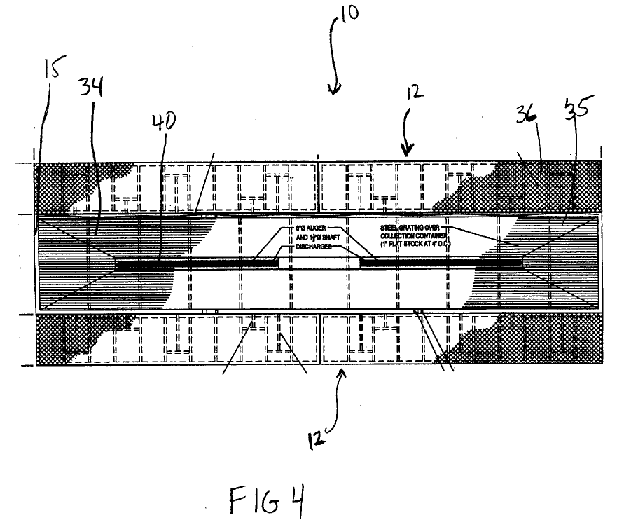

FIG. 4 is a top view of the device shown in FIG. 1. In this view, there is shown platform 12 which can be rotated out from container 15 on hinge 17. On top of container 15 can be a grating 34 which can be used to cover container 15 but still allow material such as paint chips to fall through. Workmen using this container as a platform would also be able to walk on extendable platform 12 having a surface 36 which can be in the form of a hot rolled plate or any type of solid material, once extendable platform 12 is extended out. Alternatively, this surface could be a grated surface as well. At the bottom of this container 15 is an auger, which can be used to chop up and churn out paint chips as well. In addition a tarp or other type of covering can be extended out from platform 12 to a connection on another building or bridge, which can also be used to catch additional material which may fall down.

Accordingly, while a few embodiments of the present invention have been shown and described, it is to be understood that many changes and modifications may be made thereunto without departing from the spirit and scope of the invention as defined in the appended claims.

What is claimed is:

1. A device for moving a platform on a motor vehicle comprising:
a) at least one hydraulic system;
b) at least one container coupled to the motor vehicle;
c) at least one platform;
d) at least one hinge rotatably coupling said at least one platform to said at least one container; and
e) at least one hydraulic piston in communication with said at least one hydraulic system, said at least one hydraulic piston for selectively moving said at least one platform from a first position to at least one additional position.

2. The device as in claim 1, further comprising at least one safety arm coupled to said at least one platform, wherein when said safety arm can be selectively mechanically locked in place to lock said at least one platform in place.

3. The device as in claim 1, wherein said at least one hydraulic piston is coupled to said container at a first end, and coupled to said platform at a second end, the device further comprising at least one substantially vertical hydraulic piston for providing vertical adjustment for said at least one container.

4. The device as in claim 1, further comprising a trailer coupled to the motor vehicle, wherein said at least one container is coupled to said trailer.

5. The device as in claim 4, wherein said at least one hydraulic piston is coupled to said container at a first end and coupled to said platform at a second end, the device further comprising at least one substantially vertical hydraulic piston for providing vertical adjustment for said at least one container.

6. The device as in claim 5, wherein said at least one substantially vertical hydraulic piston is coupled to said container at a first end and to said trailer at a second end, wherein said at least one substantially vertical hydraulic piston is for elevating said container off of said trailer.

7. The device as in claim 5, wherein said at least one substantially vertical hydraulic piston is coupled to said trailer at a first end and is supported on a substantially horizontal surface at a second end, wherein said at least one substantially vertical hydraulic piston is for elevating said trailer off of said substantially horizontal surface.

8. The device as in claim 2, wherein said at least one safety arm is coupled at a first end to said at least one platform and at a second end to said at least one container.

9. The device as in claim 8, wherein said at least one safety arm is a rotatable safety arm comprising:
a) a first coupling element coupled to said container;
b) a hinge coupled to said first coupling element;
c) a first arm coupled to said hinge;
d) a second coupling element coupled to said first arm;
e) a second arm rotatably coupled to said second coupling element;
f) a lock for locking rotation of said second arm vs. said first arm to lock said safety arm in place.

10. A device for moving a platform on a motor vehicle comprising:
a) at least one hydraulic system;
b) at least one container coupled to the motor vehicle;
c) at least one platform;
d) at least one hinge rotatably coupling said at least one platform to said at least one container;
e) at least one hydraulic piston in communication with said at least one hydraulic system, said at least one hydraulic piston for selectively moving said at least one platform from a first position to at least one additional position; and
f) at least one safety arm comprising a locking means for mechanically locking said at least one platform in place once said at least one platform has reached said at least one additional position.

11. A device for moving a platform on a motor vehicle comprising:
a) at least one hydraulic system;
b) at least one container coupled to the motor vehicle;
c) at least one platform;
d) at least one hinge rotatably coupling said at least one platform to said at least one container;
e) at least one hydraulic piston in communication with said at least one hydraulic system, said at least one hydraulic piston for selectively moving said at least one platform from a first position to at least one additional position; and
f) at least one safety arm comprising a lock for locking said at least one platform in place once said at least one platform has reached said at least one additional position.
